(19) United States
(12) Patent Application Publication
(10) Pub. No.: US 2016/0239847 A1
(43) Pub. Date: Aug. 18, 2016

(54) Systems and Methods for Processing Support Messages Relating to Features of Payment Networks

(71) Applicant: MASTERCARD INTERNATIONAL INCORPORATED, Purchase, NY (US)

(72) Inventors: Ravi Santosh Arvapally, O'Fallon, MO (US); Peng Yang, Chesterfield, MO (US); Walter F. Lo Faro, Chesterfield, MO (US); Kimberly S. Rodgers-Stewart, Defiance, MO (US)

(21) Appl. No.: 14/801,413

(22) Filed: Jul. 16, 2015

Related U.S. Application Data
(63) Continuation-in-part of application No. 14/620,731, filed on Feb. 12, 2015.

(51) Int. Cl. G06Q 30/00

(52) U.S. Cl. CPC G06Q 30/016

(57) ABSTRACT

Systems and methods are provided for processing messages from users, via interactive interfaces, requesting support relating to features of applications available to the users. In connection therewith, the systems and methods normalize and score the user messages, and use the scores, in combination with scores for historical messages or scores for crowdsourced messages, to identify appropriate response messages for transmittal to the users. In various aspects, the crowdsourced solutions can be voted by both users and domain experts, and also verified by the domain experts. If a solution is verified it will be flagged and it can be included into a reference solution database as a standard response. However, when the scores assigned to the messages do not produce suitable results, a request for additional information relating to the issue described by the user is transmitted via the interactive interface.

### CROSS-REFERENCE TO RELATED APPLICATION

This application is a continuation-in-part of U.S. patent application Ser. No. 14/620,731, filed on Feb. 12, 2015. The entire disclosure of the above application is incorporated herein by reference.

### FIELD

The present disclosure generally relates to systems and methods for processing support messages from users relating to features of payment networks and associated applications available to the users (e.g., available through payment service providers or other entities associated with the payment networks, available through other entities associated with other networks, etc.), and providing response messages to the users addressing issues encountered by the users and raised in the support messages.

### BACKGROUND

This section provides background information related to the present disclosure which is not necessarily prior art.

Payment accounts are known for supporting transactions for goods and services. These transactions are completed between entities associated with the payment accounts and entities associated with the goods and/or services to be purchased. The entities are connected through a payment network, through which the transactions are completed. When the entities along the payment network experience one or more issues with the payment network, and/or applications related thereto, support requests are sent to one or more entities associated with the payment network. Customer service personnel then review the support requests and respond, as appropriate, in due course in order to resolve the issues with the payment network and/or related applications.

### DRAWINGS

The drawings described herein are for illustrative purposes only of selected embodiments and not all possible implementations, and are not intended to limit the scope of the present disclosure.

FIG. 1 shows an exemplary payment network including one or more aspects of the present disclosure;

FIG. 2 is a block diagram of an exemplary computing device suitable for use in the payment network of FIG. 1;

FIG. 3 is a flowchart of an exemplary method for processing a support message, as part of a request for support, received from a customer, which can be implemented via the payment network of FIG. 1;

FIG. 4 illustrates an example progression for normalizing a support message received from a customer, according to the exemplary method of FIG. 3;

FIG. 5 illustrates an example word matrix for the normalized support message of FIG. 4;

FIG. 6 is a flowchart of another exemplary method for processing a support message from a user, as part of a request for support, which can be implemented via the payment network of FIG. 1; and

FIG. 7 shows an exemplary system including one or more aspects of the present disclosure.

Corresponding reference numerals indicate corresponding parts throughout the several views of the drawings.

### DETAILED DESCRIPTION

When issues arise with a payment network, such as with features of the payment network or with applications associated with the payment network, for example, users (e.g., customers of the payment network such as consumers, merchants, issuers, etc.; employees associated with the payment network; etc.) send support messages to entities associated with the payment network (e.g., customer service personnel, etc.) seeking assistance or resolution of the issues. Tickets may then be assigned to the support messages for use in ordering and subsequent processing. Depending on the size of the payment network, the number of users associated with the payment network, and/or the number of features associated with the payment network and various associated applications, a volume of such support messages (or tickets) may be substantial, e.g., thousands per day, etc. The systems and methods described herein help facilitate processing of the incoming support messages from the users, to efficiently provide response messages. In particular, the systems and methods, among other things, utilize interactive interfaces (e.g., chat windows, etc.) to receive the support messages from the users. The systems and methods then normalize and score the support messages, and use the scores, in combination with scores for historical support messages or scores for crowdsourced support messages, to identify appropriate response messages for transmittal to the users.

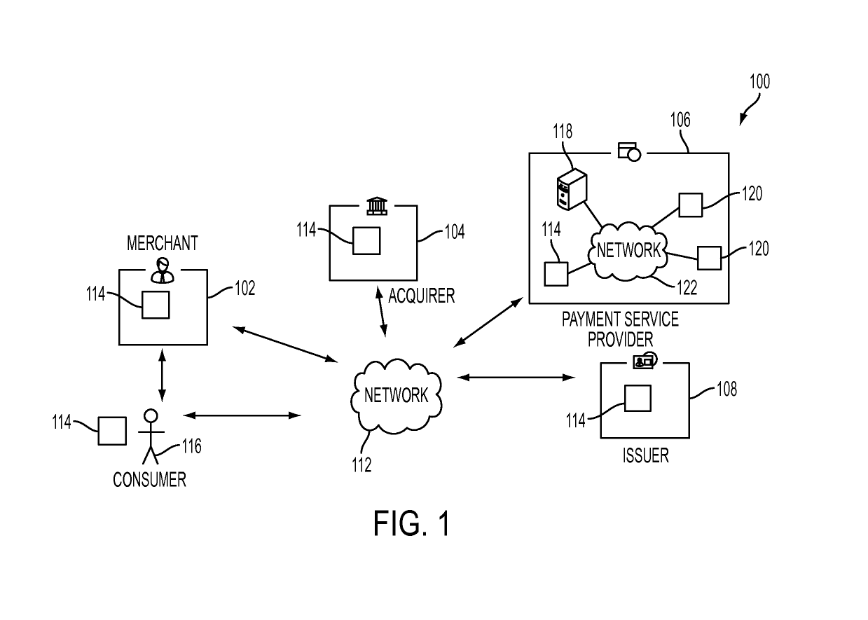

FIG. 1 illustrates an exemplary payment network 100, in which the one or more aspects of the present disclosure may be implemented. Although components of the payment network 100 are presented in one arrangement, other embodiments may include the same or different components arranged otherwise, depending, for example, on processing of payment account transactions, etc. In addition, while the various aspects of the present disclosure are described herein as implemented in the payment network 100, it should be appreciated that the various aspects of the present disclosure are not limited to the payment network 100 and may be implemented in other networks (e.g., in networks other than payment networks, etc.) or systems.

The illustrated payment network 100 generally includes a merchant 102, an acquirer 104, a payment service provider 106, and an issuer 108, each coupled to network 112. The network 112 may include, without limitation, one or more local area networks (LAN), wide area networks (WAN) (e.g., the Internet, etc.), mobile networks, virtual networks, other networks as described herein, and/or other suitable public and/or private networks capable of supporting communication among two or more of the illustrated components, or even combinations thereof. In one example, network 112 includes multiple networks, where different ones of the multiple networks are accessible to different ones of the illustrated components in FIG. 1. In this embodiment, each of the merchant 102, the acquirer 104, the payment service provider 106, and the issuer 108 include a computing device 114 coupled to the network 112. Each computing device 114 may include a single computing device, or multiple computing devices located together and/or distributed across a geographic region.

The payment network 100 further includes a consumer 116, who transacts with the merchant 102 for the purchase of goods and/or services. Transactions may occur in-person at a location associated with the merchant 102, or remotely via telephonic, network, or other connections between the merchant 102 and the consumer 116 (e.g., via network 112, etc.). In this example embodiment, the consumer 116 is also associated with a computing device 114. While only one merchant 102, acquirer 104, issuer 108, and consumer 116 are shown, a different number of one or more of these entities may be included in other embodiments. In addition, for purposes of the description herein, each is referred to as a “customer” of the payment network 100, and the payment service provider 106. More generally, exemplary systems and methods are described herein with reference to the payment service provider 106, of the payment network 100, for purposes of illustration. However, the systems and methods herein may be employed in other entities, or other parts, of a payment network or in other networks (or systems) in other embodiments.

In general in the payment network 100, the merchant 102, the acquirer 104, the payment service provider 106, and the issuer 108 cooperate to process a request from the consumer 116 to complete a payment account transaction with the merchant 102, via a payment device (e.g., a credit card, a debit card, a pre-paid card, a payment token, a payment tag, a pass, another device used to provide account information (e.g., a smartphone, a mobile application, a tablet, etc.) etc.). In the exemplary embodiment, the consumer 116 initiates the transaction by presenting a credit card to the merchant 102. In such a credit transaction, for example, the merchant 102 reads the credit card and communicates the associated account information, the amount of the purchase, and/or other information to the acquirer 104 to determine whether sufficient credit exists to complete the transaction.

The acquirer 104, in turn, communicates with the issuer 108, through the payment service provider 106 (and the network 112), for authorization to complete the payment account transaction. If the issuer 108 accepts the transaction, an authorization response is provided back to the merchant 102 and the merchant 102 completes the transaction. The credit line of the consumer 116 is altered by the amount of the transaction, and the charge/credit is posted to the account associated with the credit card. The transaction is later cleared and/or settled by and between the merchant 102 and the acquirer 104, and by and between the acquirer 104 and the issuer 108. Debit and pre-paid payment device transactions are substantially similar to the above, but, in some examples, may further include the use of a personal identification number (PIN) authorization and more rapid posting of the charge/credit to the account associated with the device, etc.

Each payment account transaction, and its communication through the merchant 102, the acquirer 104, the payment service provider 106, and the issuer 108, whether complete or not, involves one or more features of the payment network 100 and applications associated therewith. Regardless of whether the features are available at the issuer 108, the consumer 116, the acquirer 104, or the payment service provider 106, the features often are associated with and/or provided by the payment service provider 106. In general, such features may relate to authorization of transactions, clearing of transactions, settlement of transactions, data access, document retrieval, chargebacks, reporting, security (or fraud), or any other features associated with the payment network 100 (or with one or more other payment networks), etc. However, it should be appreciated that several different features (and related applications) may be associated with the different processes, for which the payment network 100 may be utilized. As an example, the features may relate to a digital wallet associated with the payment service provider 106 (and the issuer 108), which is usable by the consumer 116. As another example, the features may relate to the flow of transaction data between the acquirer 104 and the issuer 108, through the payment service provider 106 for authorization, settlement, and other processing of transactions (e.g., features supported by MasterCom™ systems, etc.). Again, while the current description relates to features (and associated applications) of the payment network 100, it should be appreciated that the systems and methods can equally apply to networks (or systems) supporting features other than payment-based features within the scope of the present disclosure.

With continued reference to FIG. 1, the payment service provider 106 includes a support engine 118 (broadly, a ticket resolution system, or system). The support engine 118, as referenced herein, is a computing device, which may be a single computing device, or multiple computing devices located together and/or distributed across a geographic region. As shown, in this exemplary embodiment, other computing devices 120 are included in communication with the support engine 118 (and with the computing device 114), via a network 122. The computing devices 120 may include a computing device associated with customer support personnel (e.g., employees of the payment service provider, etc.) (broadly, representatives), located together and/or distributed across a geographic region, etc. In addition, the network 122 may be a part of network 112, or separate therefrom, and may include, without limitation, a local private intranet, a local area network (LAN), a wide area private network, a wide area public network (e.g., the Internet, etc.), a mobile network, and/or another suitable network capable of supporting communication between the support engine 118 and the network 112 (and/or computing devices 114 and 120).

Each computing device 114, 118 and 120 in the system may include, without limitation, a server (e.g., an application server or web server, etc.), a desktop computer, a laptop computer, a workstation computer, a personal computer, a tablet computer (e.g., an iPad™, a Samsung Galaxy™, etc.), a handheld computer or other communication device (e.g., a netbook, a specialized reservation device, etc.), a smart phone (e.g., an iPhone™, a BlackBerry™, a HTC™ phone, etc.), the like, or combinations thereof.

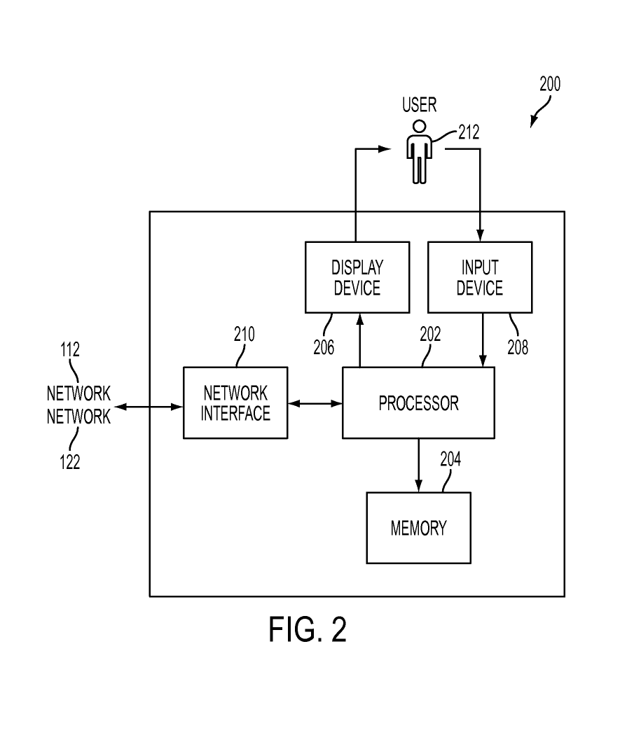

FIG. 2 illustrates an exemplary computing device 200. For purposes of the description herein, each of the computing devices 114, 118 and 120 shown in FIG. 1 is a computing device, consistent with computing device 200. However, it should be appreciated that the computing devices 114, 118, and 120 of FIG. 1 should not be understood to be limited to the arrangement of the computing device 200, as depicted in FIG. 2. Different components and/or arrangements of components may be used in other computing devices. In various embodiments, the computing device 200 includes multiple computing devices located in close proximity, or distributed over a geographic region.

The exemplary computing device 200 includes a processor 202 and a memory 204 that is coupled to the processor 202. Processor 202 may include one or more processing units (e.g., in a multi-core configuration, etc.). Computing device 200 is programmable to perform one or more operations described herein by programming the memory 204 and/or processor 202. Processor 202 may include, but is not limited to, a general purpose central processing unit (CPU), a microcontroller, an instruction set computer (e.g., reduced, complex, etc.) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

Memory 204, as described herein, is one or more devices that enable information, such as executable instructions and/or other data, to be stored and retrieved. Memory 204 may include one or more computer-readable storage media, such as, without limitation, dynamic random access memory (DRAM), static random access memory (SRAM), a solid state disk, and/or a hard disk. Memory 204 may be configured to store, without limitation, support messages, reference support messages, values associated with reference support messages, response messages, predefined lists of words, etc. In this embodiment, the memory 204 includes a set of values such as score vectors, each associated with a reference support message and/or a response message. The values in memory 204 are, for example, determined according to the methods described herein, for use in identifying, by the processor 202, a response message for a given support message.

In the exemplary embodiment, computing device 200 includes a display device 206 that is coupled to processor 202. Display device 206 outputs to a user 212 by, for example, displaying and/or otherwise outputting information such as, but not limited to, chat windows, support messages, response messages, etc. Display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices. It should be further appreciated that various interfaces (e.g., chat windows, graphical user interfaces (GUI), webpages, etc.) may be displayed at computing device 200, via the display device 206. The user 212 may include the customer, as described herein, for example, the merchant 102, the acquirer 104, the issuer 108, or the consumer 116, or the user 212 may include customer service personnel (e.g. an employee, etc.) of the payment service provider 106, or the user 212 may include an employee or affiliate of other entities not shown in FIG. 1, etc.

In the exemplary embodiment, computing device 200 further includes an input device 208 that receives input from the user 212, such as the customer described herein or the customer service personnel. For example, input device 208 may be configured to receive any desired type of inputs from the user 212, for example, as part of compiling and transmitting a support message, compiling and transmitting a response message, etc. In the exemplary embodiment, input device 208 is coupled to processor 202 and may include, for example, a keyboard, a pointing device, a mouse, a stylus, a touch sensitive panel (e.g., a touch pad or a touch screen, etc.), and/or an audio input device. Further, in various exemplary embodiments, a touch screen, such as that included in a tablet or similar device, functions as both display device 206 and input device 208.

In the exemplary embodiment, computing device 200 also includes one or more network interface devices 210 coupled to processor 202. Network interface device 210 may include, without limitation, a wired network adapter, a wireless network adapter, a mobile telecommunications adapter, or other device capable of communicating to one or more different networks, including the network 112 and/or the network 122. In at least one embodiment, computing device 200 includes processor 202 and one or more network interface devices 210 incorporated into or with processor 202.

In further embodiments, computer-executable instructions are stored on non-transitory memory 204 for execution by processor 202 to perform one or more of the functions described herein. These instructions may be embodied in a variety of different physical or tangible computer-readable storage media, such as memory 204 or other non-transitory memory, including, without limitation, a flash drive, CD-ROM, thumb drive, floppy disk, etc.

With continued reference to FIG. 1, in the illustrated embodiment, when issues or problems arise with features of the payment network 100, the customer (whether the merchant 102, the acquirer 104, the issuer 108, or the consumer 116), or another user, utilizes a computing device (e.g., computing device 114, computing device 120, etc.) to provide a support message (e.g., via email, via an interactive chat window, etc.) to the payment service provider 106. Support messages are described in more detail below.

In response, the support engine 118 of the payment service provider 106 is configured to, among other things, receive the support message (and any other support messages related to the payment network 100), normalize the support message, assign a value (e.g., a score such as a score vector representing a frequency count of words in a document, etc.) to the normalized message, identify a response message based on the assigned value, and transmit the response message back to the customer, or other user, from which the support message originated (and/or to another party, etc.). In some implementations, the support engine 118 further requests additional information from the customer, or other user, relating to an issue presented in the support message, for example, when an initial solution is not available. In this manner, the support engine 118 operates, interactively, with the customer, or other user, to find the best or, in some embodiments, the closest, solution available.

In some aspects of the system 100, the support engine 118 utilizes historical support messages as well as crowdsourced support messages, to identify appropriate response messages for transmittal to the customer. The crowdsourced support messages can be provided from customer service personnel or other domain experts, for example, based on their personal experience, for various support messages submitted by other customer service personnel or other users. These support messages may be unique in nature, for example, and not normally encountered. In addition, the crowdsourced support messages may originate internally, for example, from employees of the payment network 108, or they may originate externally, for example, from experts not affiliated with the payment network 108 and/or system 100. Further, in some aspects, the crowdsourced solutions can be proposed and/or voted by both users and domain experts, and also verified by the domain experts. If a solution is verified it will be flagged and it can be included into the reference solution database as a standard response.

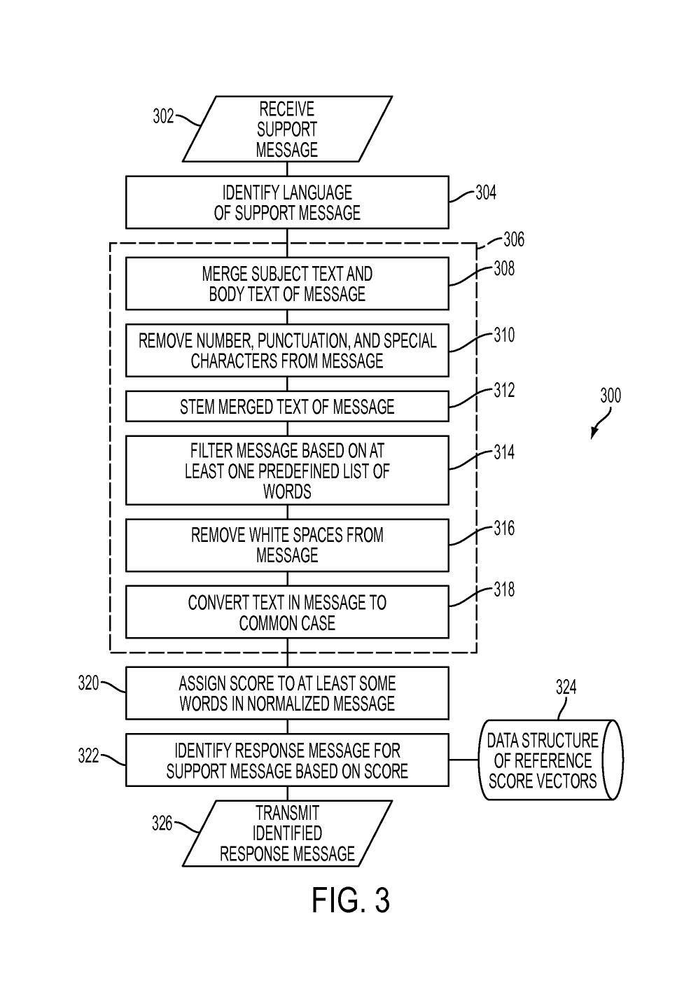

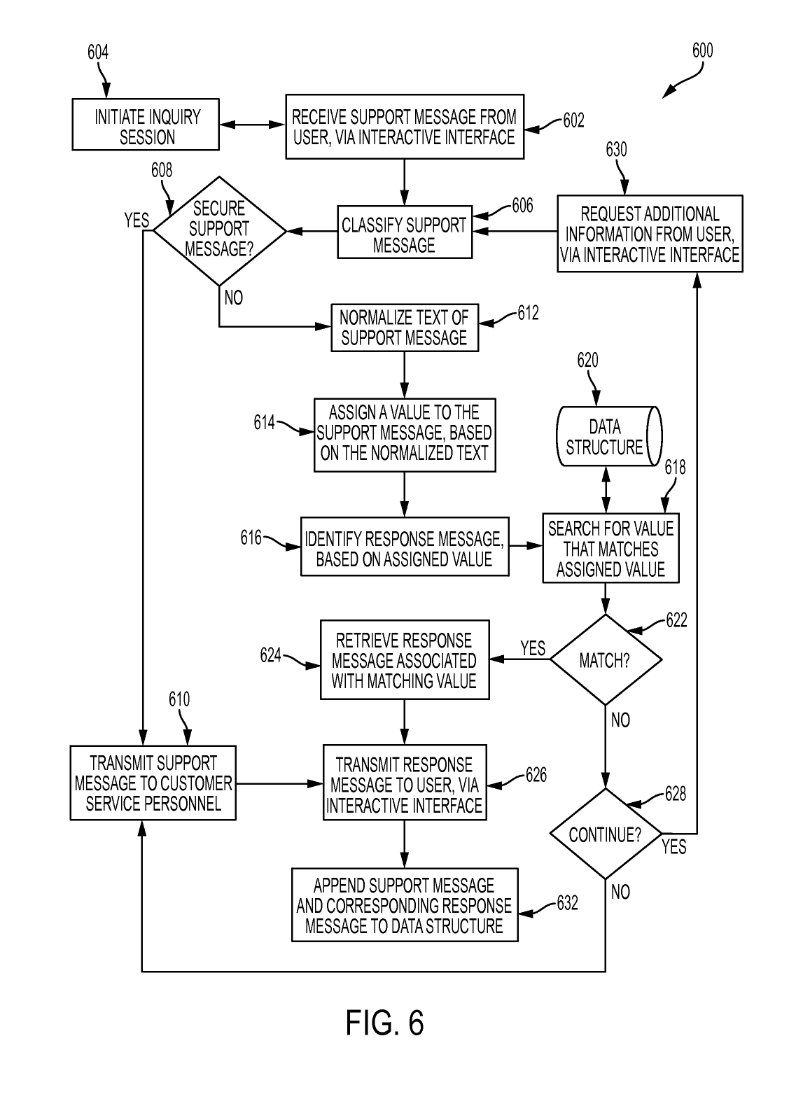

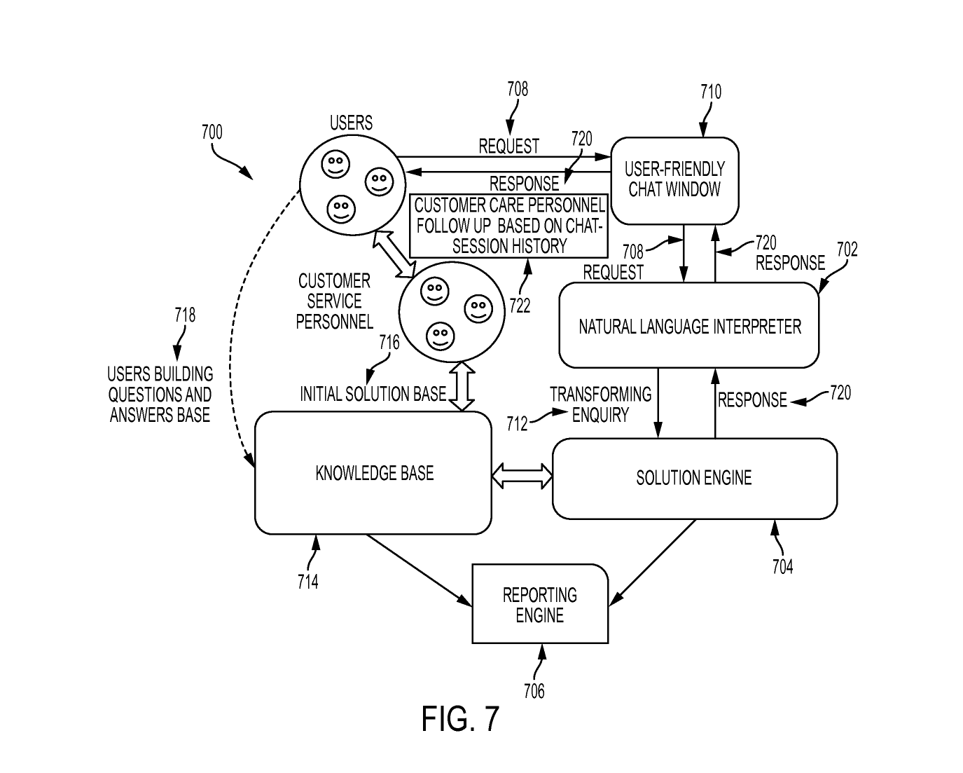

Specific configurations of the exemplary support engine 118 are further described below with reference to the exemplary method 300 of FIG. 3 and the exemplary method 600 of FIG. 6, and the exemplary system 700 of FIG. 7. It should be appreciated, however, that the method 300, the method 600, and the system 700, and any other methods described herein, are not limited to the exemplary payment network 100, or the computing device 200, but may be implemented in a variety of different networks, systems and/or computing devices (e.g., in other computing devices in the payment network 100, or in computing devices of another network). Likewise, the payment networks, systems, engines, and computing devices described herein should not be understood to be limited to the exemplary method 300, or the exemplary method 600, or other methods described herein.

FIG. 3 illustrates method 300 for processing a support message from a customer. It should be appreciated that method 300 represents only one exemplary group of operations for processing the support message, and that other methods may include other groups of operations as desired. In addition, the operations illustrated in connection with the method 300 are exemplary in nature, and may be used in connection with the other methods, for example, with the same or with different operations, or not used at all.

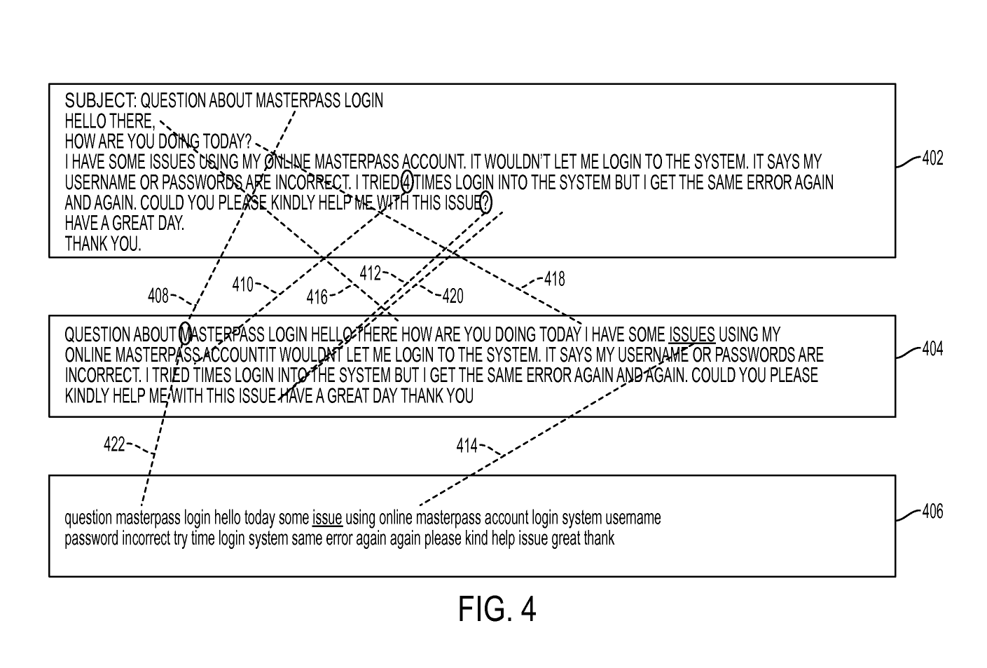

The method 300 is further described herein with reference to the exemplary support message 402 illustrated in FIG. 4. The support message 402, generically, is indicative of an issue being experienced by a customer of the payment network 100 and/or relates to a feature of the payment network 100 or an application associated therewith. While the exemplary message 402 is an email and is provided by the customer in text, it should be appreciated that other types/forms of messages may be processed by the support engine 118 described herein, and/or according to one or more of the methods described herein. For example, support messages may be received by the engine 118 again in text, via a real time chat-based interaction with the customer, or it may be provided from customers in audible mediums (e.g., voicemails, etc.) or other mediums, which are then converted to text.

Referring to FIG. 3, a customer associated with the payment network 100 may initially send a support message (e.g., support message 402 in FIG. 4, another support message, etc.), when an issue or problem with one or more features of the payment network 100 is realized. Issues may include, for example, and without limitation, login errors, forgotten passwords, failed prepaid reloads, failed money transfers, lost/stolen cards, security token issues, “How do I” issues, declined transactions, data integrity issues, settlement errors, clearing errors, application-specific issues (e.g., related to MasterCard® inControl™ services, etc.), monitoring flags/alerts, etc. The support engine 118, in turn, receives, at 302, the support message from the customer. The support engine 118 may receive the support message in a variety of different ways depending on, for example, the format of the support message (e.g., email, voicemail, from a chat system, etc.) and/or the networks 112/122.

As an example, the support message may be an email from the consumer 116, including both subject text and body text, which is received via network 112. Further, the email may be received via a link listed on a webpage (or on a feedback form available on a webpage) associated with the payment service provider 106, or via a webpage of another entity shown (or not shown) in FIG. 1. In addition in this example, if the consumer 116 experiences an issue with the merchant 102, or the issuer 108, for example, the consumer 116 may direct the support message to the merchant 102 or the issuer 108. The merchant 102 or issuer 108, or other may then send, or forward, the support message to the payment service provider 106 (and the support engine 118), as appropriate, for response. Alternatively, in some embodiments, possibly depending on the issue raised in the support message, the merchant 102 or issuer 108 may retain the support message and respond to the consumer 116 directly, either without forwarding the message to the payment service provider 106 or in parallel with forwarding the message to the payment service provider 106.

Next in the method 300, after receiving the support message from the customer, the support engine 118 identifies an original language associated with the message, at 304 (e.g., English, Spanish, German, Chinese, etc.). The support engine 118, after identifying the language, in this particular embodiment, either translates the message to a particular predetermined language (e.g., English, etc.), or processes the message, as described below, in its original language. In some embodiments, it may be preferred to convert to a single language, so that processing of the message is consistent regardless of its original language. In such embodiments, it is further preferred, although not required, to provide a response message, to the support message, in the same language as the original support message. In the example of FIG. 4, the support message 402 is in the English language, and is processed, as described below, in English.

The support engine 118 then normalizes the support message, at 306. The message is normalized to enable, in this embodiment, efficient processing of the message. As indicated by the broken lines in FIG. 3, multiple different normalization techniques are employed at 306 to normalize the message. It should be appreciated, however, that a different number of techniques may be included in other embodiments, with some of the techniques described herein included or omitted. In addition, the techniques indicated in FIG. 3, at 306, may be performed in the order illustrated, or in different orders as appropriate.

In connection with normalizing the support message, in this exemplary embodiment, the support engine 118 initially merges, at 308, subject text and body text of the message into a common text portion. As an example, in FIG. 4, the subject text and body text of the support message 402 are merged together, at 408 (and at other places), into a common text portion, represented by intermediate message 404. Next in the method 300, the support engine 118, in normalizing the message, removes, at 310, numeric characters, punctuation characters, and special characters from the support message. It should be appreciated, however, that number characters, punctuation characters, and/or special characters may be preserved in other embodiments. For example, if a particular special character, or punctuation character, is determined to be indicative of a certain issue, or solution, that character may be preserved, rather than removed, to improve the processing of the message. Again as an example, in FIG. 4, as shown in the intermediate message 404, the number character “4” is removed from the support message 402, at 410, and the punctuation character “?” is removed from the support message 402, at 412, among others.

At 312 in the method 300, the support engine 118 removes white spaces in the message, including carriage returns, multiple spaces, etc. However, a single space may be preserved between words in the support message to delineate between the different words (but this is not required). In the example of FIG. 4, the carriage returns are removed after the words “there,” at 416, “today?” at 418, and “issue?” at 420, among others. After 312, the support engine 118 converts the text in the message to a common case, at 314, either uppercase or lowercase. In the example of FIG. 4, the text is converted to lowercase, e.g., at 422, etc., in processing from the intermediate message 404 to the normalized message 406.

At 316 in the method 300, the support engine 118 stems the merged text of the support message. In this exemplary embodiment, stemming includes replacing words with root terms, or particular forms of a word. As such, similar words (or words with similar or the same meanings) are not counted as different words in further steps of the method 300. For example, “running,” “ran,” and “run” are all forms of the word “run,” but are used in different contexts. Stemming, as used herein, causes “running” and “ran” to be replaced with the root term “run.” In the example of FIG. 4, as part of stemming, the word “issues” in the intermediate message 404 is replaced with the root word “issue,” at 414, in normalized message 406, essentially replacing the plural form of the word with the singular form as the root word (however, it should be appreciated that the singular form of words are not always the root words).

At 318 in the method 300, the support engine 118 filters the text of the support message based on words included in at least one predefined list of words.

The at least one predefined list of words may include a predefined stop list, which includes words to be “stopped” or removed from the support message. Words included in the predefined stop list are often frequently used, and thus may have limited potential to aid in the determination of the issue referenced/raised in the support message, or in the determination of a cause or solution to that issue. As can be appreciated, by removing words from the support message, as included in the predefined stop list, remaining words may be processed more efficiently. It should also be appreciated that the predefined stop list may be used, by the support engine 118, against all messages, i.e., it may be generic, or the predefined stop list may be specific to particular messages based on, for example, an origin of the message, pre-processing of the message, keyword searching within the message, a category of the message, etc. Further, it should be appreciated that a wide variety of words may be included, or excluded, from a predefined stop list, according to a variety of criteria. In the example of FIG. 4, the intermediate message 404 is filtered based on a predefined stop list that includes the words: about, there, I, have, and some (however, the list could include more, less, or different words). As such, in the normalized message 406, these terms are removed (as compared to the original support message 402 and the intermediate message 404 where they are included).

The predefined stop list of words may be compiled, by the payment service provider 106 or another entity, manually and/or automatically, based on, for example, frequency of the words in a particular message, origin of a message, a type of message, etc., or it may be compiled based on a frequency of words included in numerous prior (historical) messages received at the support engine 118, etc. In addition, multiple different stop lists may be compiled, each applicable to a different category or type of support message. In one embodiment, term frequency-inverse document frequency (TF-IDF) is employed on all of the terms/words that appear in all of the received support messages, by the support engine 118, to identify words to be included in the predefined stop list (or to generate multiple different predefined stop lists). For example, for a set of messages including 7,500 terms, the terms are organized (by TF-IDF score) in increasing order. Then, the top 500 of the organized terms (or a different number of terms) are submitted for review by customer service personnel of the payment service provider 106 (or of other entities), for example, who decide if the terms should be included or excluded from the predefined stop list. This permits the customer service personnel, or other, to provide input to the processing of support messages.

The at least one predefined list of words may also (or alternatively) include a predefined keep list, used by the support engine 118 for “keeping” or preserving words in the support message. Here, the words are preserved in the message, even if included in a predefined stop list as described above. For example, the support engine 118 may define a keep list, per message, as the words included in the subject text of the message. Generally, the subject text is the customer's first indication of the issue with the payment network 100, and on this basis, in some embodiments, the words of the subject text may be preserved even if frequently used. Nonetheless, in other examples, words included in the subject text, like words in the body text, may be subject to removal based on a predefined stop list. Generally, the predefined keep list is compiled manually and/or automatically, and based on one or more criteria, such as, for example, the occurrence of a related word in the body text of the message, etc.

While normalization of the message 306 is described herein, at 308-318, in connection with the exemplary method 300, it should be appreciated that the same or different techniques (or different orders of techniques 308-318) of normalizing the support message may be employed in other embodiments, so that the message is suitable for further processing as described herein. Additionally, it should be appreciated that more or less normalization techniques may be employed in other embodiments, depending, for example, on the further processing to be performed on the support message. In at least one embodiment, normalization of the support message is even omitted.

With that said, after normalizing the message, the support engine 118 assigns a score to the support message, at 320, and stores the assigned score in memory 204 of computing device 114 associated with the payment service provider 106. In particular in the method 300, the support engine 118 assigns a score vector to the support message, which includes multiple scores, i.e., a score associated with (or assigned to) at least some of the individual words included in the normalized message. In some embodiments, all words in a support message are each assigned a score, with the group of scores for the message then forming the score vector. In other embodiments, however, less than all words in a support message are assigned a score (as part of forming the score vector).

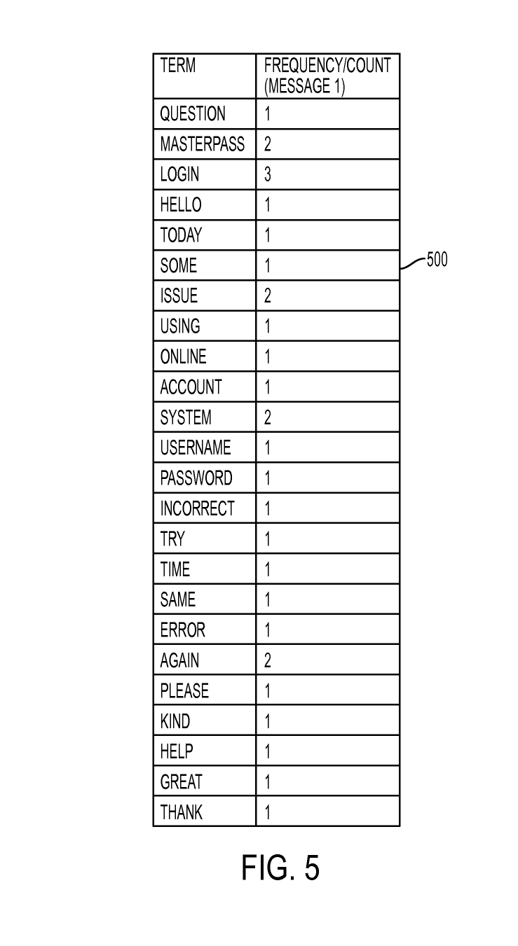

FIG. 5 illustrates an example word matrix 500 for the normalized support message 406 of FIG. 4. As shown, the score for each word in the normalized support message 406 is arranged into the word matrix 500. Although only scores for the example normalized support message 406 are included in the word matrix 500, it should be appreciated that other support messages may be represented in, or stacked in, the matrix 500 in additional columns, with additional words added as necessary to provide an accurate score vector of each of the additional support messages. For example, for 123 support messages, having a total of 456 unique words in all of the normalized messages together, a word matrix will have a size of 123×456. Here, each column of the matrix 500 would then represent one of the multiple support messages, and each row would then represent scores in the different support messages for the particular words. Further, each support message would then have a score vector in the context of the matrix 500. As should be appreciated, by use of a common matrix across the multiple support messages, score vectors for the messages may be more easily compared.

In the word matrix 500 of FIG. 5, the scores represent the term-frequency scores for each word in the normalized message 406. As such, the score vector for the normalized message 406 is (1, 2, 3, 1, 1, 1, 2, 1, 1, 1, 2, 1, 1, 1, 1, 1, 1, 1, 2, 1, 1, 1, 1, 1). This score vector may be changed or altered, as desired, for example, depending on ordering of the words in the matrix 500, etc. Further, in this example, while the number of occurrences of the words in the message 406 is directly indicative of the word scores (and the resulting score vector) for the message 406, other criteria may be used to assign scores, per word or otherwise, in other embodiments. Often, however, the scores are associated with the frequency of the words in the particular message being evaluated, either directly or indirectly. In one or more embodiments, the support engine 118 may further employ principal component analysis (PCA) to the score vector in the matrix 500 in order to reduce dimensionality. PCA is an orthogonal transformation, which transforms correlated variables (i.e., the occurrence of terms in normalized support messages, etc.) into linearly uncorrelated variables. Each is called a principal component. The support engine 118 then operates on the first ‘K’ principal components, based on the variance.

In other embodiments, score vectors may be assigned to normalized support messages (or other messages) based on a type of algorithm to be used in assigning predictive labels to the messages and/or in identifying response messages, as described below. In these embodiments, the score vectors, for example, may include continuous values, or discrete scores, in binary values. In addition, the score vectors may be subject to weighting based on one or more condition, including, for example, word frequency, etc. Further, while the score vectors are based on term frequencies, the support engine 118 may also assign score vectors based on TF-IDF or binary weighting schemes. Term frequency, as described above, includes the frequency at which a term appears in a support message. Binary weighting includes identifying a score in the vector as either “0” or “1”, where the “0” indicates the word is not present in the message and the “1” indicates the word is present in the message. TF-IDF, as used herein, includes a scheme (e.g., a weighting scheme), in which TF is the number of times a term is present in a message divided by the total number of terms in the message, and IDF is the logarithm of the total number of support messages (over a predefined interval) divided by the total number of support messages including the term. For example, one support message, in a group of 10 million support messages, includes 100 words, in which the word “login” appears 3 times. In the 10 million messages, 1,000 if the messages include the word “login.” The TF is 0.03 (i.e., 3/100), and the IDF is 4.0 (i.e., log(10,000,000/1000)). Thus, the TF-IDF is 0.12 (i.e., 0.03×4). In this example, the score vector for the support message would be 0.12, as corresponding to the word “login.” Additional score vectors may similarly be calculated for the support message, for one or more of the other words in the message.

In any case in the method 300, once the score vector is assigned to the normalized support message, the support engine 118 identifies a response message, at 322, based on the score vector. In particular, the support engine 118 searches in a data structure 324, which includes a plurality of reference score vectors, for a score vector that matches (or substantially matches) within a predefined threshold. In some embodiments, the match represents an identical match between the score vector assigned to the normalized support message and a score vector in the data structure 324 (where the identical match indicates the threshold is satisfied). In other embodiments, the match represents a substantial match between the score vector assigned to the normalized support message and a score vector in the data structure 324 (e.g., the score vector is within the predefined threshold of a score vector in the data structure 324 on a per score basis, or a per score vector basis, etc.). Examples of substantial matches will be provided hereinafter. The predefined threshold, for example, is generally determined through empirical iterations of support messages with known responses. Broadly, the data structure 324 includes a plurality of support messages, to which manual processes have been employed to assign labels and/or response messages. A first set of these messages, i.e., reference support messages, are processed according to the steps described above for method 300. The score vectors for these messages are then associated with the appropriate response messages in the data structure 324 (which are assigned to the support messages manually). Then, the steps of the method 300, through step 322, are completed for a second set of the messages, with the support engine 118 identifying response messages from the data structure 324 based on matching ones of the score vectors for the second set of messages to the score vectors for the first set of messages (i.e., the reference support messages), based on some predefined threshold. The identified responses for the second set of messages are then compared with the manually assigned responses for the first set of messages. As needed, the steps may be repeated, and the predefined threshold may be adjusted, so that the identified responses to the second set of messages are altered, as appropriate, to match the identified responses for the first set of messages. When the support engine 118 yields a sufficient success rate for the reference score vectors and one or more predefined thresholds, the support engine 118 may be further employed as described herein and below.

In some embodiments, cosine similarity metrics may be used to determine matches between (and compare) score vectors assigned to normalized support messages and reference score vectors associated with response messages (e.g., stored in data structure 324, etc.). The results are then evaluated in view of one or more desired predefined thresholds, for example, determined as described above (e.g., through empirical iterations, etc.). However, it should be appreciated that any number of different matching techniques may be used to compare a score vector for a support message to a score vector of one or more reference messages.

In addition, in some embodiments, the following cosine similarity measure may be employed:

$$cos θ = \frac{A . B}{‖ A ‖ ‖ B ‖} = \frac{{\sum }_{i = 1}^{n} {A}_{i} {B}_{i}}{\sqrt{{\sum }_{i = 1}^{n} {( {A}_{i} )}^{2}} \sqrt{{\sum }_{i = 1}^{n} {( {B}_{i} )}^{2}}} \qquad ( 1 )$$

where “cos θ” represents the match value (on a range from 0 to +1, for example, where +1 would essentially represent an identical match); “A” represents the score vector assigned to the normalized support message; and “B” represents the reference score vector (to which the score vector assigned to the normalized support message is compared).

In one example application, a score vector of (1, 4, 1, 2, 4, 2, 1, 1, 1, 1, 4) is assigned to a normalized support message (e.g., via the method 300, etc.). As part of determining the appropriate response message, the support engine 118 compares the score vector to reference score vector (1, 4, 2, 2, 4, 2, 1, 1, 1, 1, 4) (among others), using equation (1), for example, to determine if the score vector assigned to the support message matches the reference score vector. In so doing, the support engine 118 determines that a match value for cos θ is 0.9924. In this example, a match is considered substantially matching (or as satisfying a predefined threshold), when the match value is greater than a threshold value of about 0.7 (e.g., as determined through various empirical interactions, etc.). As such, the value calculated for cos θ of 0.9924 is greater than 0.7, indicating that the two score vectors are considered a match.

In another example application, a score vector of (1, 0, 3, 1, 2) is assigned to a normalized support message (e.g., via the method 300, etc.). As part of determining the appropriate response message, the support engine 118 compares the score vector to reference score vector (0, 0, 1, 0, 1) (among others), using equation (1), for example, to determine if the score vector assigned to the support message matches the reference score vector. In so doing, the support engine 118 determines that a match value for cos θ is 0.9. In this example, a match is again considered substantially matching (or as satisfying a predefined threshold), when the match value is greater than the threshold value of about 0.7. As such, the value calculated for cos θ of 0.9 is greater than 0.7, indicating that the two score vectors are considered a match.

In still another example application, a score vector of (2, 1, 0, 2, 0, 0, 0, 0) is assigned to a normalized support message (e.g., via the method 300, etc.). As part of determining the appropriate response message, the support engine 118 compares the score vector to reference score vector (2, 0, 1, 0, 1, 0, 1, 1) (among others), using equation (1), for example, to determine if the score vector assigned to the support message matches the reference score vector. In so doing, the support engine 118 determines that a match value for cos θ is 0.4714. In this example, a match is again considered substantially matching (or as satisfying a predefined threshold), when the match value is greater than the threshold value of about 0.7. As such, the value calculated for cos θ of 0.4714 is less than 0.7, indicating that the two score vectors are not considered a match.

In some embodiments, the support engine 118 may match more than one reference message, when, for example, the score vectors match according to the threshold employed by the support engine 118. In such embodiments, the support engine 118 selects a close match (e.g., a best match, etc.), based on the techniques employed to match the message, and/or identifies/communicates some or all of the matching messages and/or associated response messages to customer service personnel for evaluation. In the later instance, the customer service personnel may then select one or more of the response messages to be transmitted to the customer, as describe below.

In some embodiments, response messages may include predictive labels, which describe, briefly, issues and/or questions raised in the original support messages. The predictive labels may be used in one or more ways, by customer service personnel, to verify and/or check response messages, regularly or at certain regular or irregular intervals, to confirm performance of the support engine 118. The response messages also generally include predefined solutions for the issues and/or questions (e.g., videos, links to videos/documents, webpages, self-help instructions, blogs, etc.) based on, at least in part, prior manual analysis of the reference messages and/or continued review of support messages processed according to the automated methods herein, for example, by the support engine 118. Table 1 illustrates an example listing of 10 labels that may be included with response messages, and which may be identified by the support engine 118. As shown, the first column includes a response label designation, the second column includes a predictive label, and the third column includes a content included with the corresponding response message.

TABLE 1
Issue Classification Labels and their Responses

| | | |
|---|---|---|
| Label 1 | Product 1/Issue 1/Action 1 | Video Tutorial 1 |
| Label 2 | Product 1/Issue 2/Action 2 | User Manual 2 |
| Label 3 | Product 2/Issue 3/Action 1 | Video Tutorial 3 |
| Label 4 | Product 3/Issue 4/Action 2 | URL to solution |
| Label 5 | Product 3/Issue 5/Action 2 | Video Tutorial 4 |
| Label 6 | Product 3/Issue 1/Action 1 | User Manual 3 |
| Label 7 | Product 3/Issue 2/Action 3 | Video Tutorial 5 |
| Label 8 | Product 3/Issue 3/Action 1 | User Manual 1 |
| Label 9 | Product 3/Issue 6/Action 3 | Video Tutorial 2 |
| Label 10 | Product 4/Issue 1/Action 1 | URL to solution |

Further, in some embodiments, the response messages are identified by the support engine 118 (e.g., at 322 in method 300, etc.) based on, in part, information about the customer. Specifically, for example, when a customer is known to the payment service provider 106 to subscribe to particular features of the payment network 100, the support engine 118 may employ the identity of the customer from whom the support message was received to limit the search in the data structure 324. When the customer is consumer 116, for example, the support engine 118 may identify the consumer 116 as having a digital wallet supported by the payment service provider 106, and then limit the categories of response messages to those related to digital wallet features. It should be appreciated that other criteria may be employed, by the support engine 118 or the payment service provider 106, to identify response messages for particular support messages or for particular customers, and/or to provide efficiency in the identification of response messages.

With reference again to FIG. 3, upon identifying the response message, the support engine 118 automatically transmits, at 326, the identified response message to the customer from whom the support message was received (after translating the language, in some embodiments, if necessary). The response message generally includes at least one instruction related to the issue included in the support message. The at least one instruction will be specific to the issue, and will provide one or more solutions for the issue. Any suitable format may be used to convey this information to the customer, either directly in the response message, or through content linked to the response message. For example, the response message may include, without limitation, a video tutorial relating to the issue indicated in the support message, a user manual relating to the issue indicated in the support message, a link (e.g., a URL, etc.) to a written description relating to the issue indicated in the support message, and/or a link to a video description relating to the issue indicated in the support message.

FIG. 6 illustrates another exemplary embodiment of a method 600 for use in processing a support message, from a user, relating to an issue or problem encountered by the user with one or more features of an application available to the user through the payment network 100 or otherwise. The method 600 makes use of historical messages as well as crowdsourced messages, to identify an appropriate response message for transmittal to the user.

The exemplary method 600 is described herein as implemented in the support engine 118 of the payment network 100, and with additional reference to the various entities of the payment network 100 and to the computing device 200. Again, however, the method 600 should not be understood to be limited to the payment network 100 and/or computing device 200, as other networks, systems and computing devices may be employed to perform the method 600. Conversely, payment network 100 and computing device 200 should not be understood to be limited to or by the method 600.

Referring to FIG. 6, in the method 600, when a user encounters an issue or problem with the payment network 100, or with one or more features of an application associated with the payment network 100, the user submits a support message (broadly, a request for support, or a request) describing the issue. As previously described, the issue may relate to login errors, forgotten passwords, failed prepaid reloads, failed money transfers, lost/stolen cards, security token issues, “How do I” issues, declined transactions, data integrity issues, settlement errors, clearing errors, application-specific issues (e.g., related to MasterCard® inControl™ services, etc.), monitoring flags/alerts, etc. The support engine 118, in turn, receives the support message, at 602.

In the illustrated embodiment, the user submits the support message through an interactive interface, displayed to the user, at display device 206 of the user's computing device 200, by the support engine 118. For example, the interface may include a chat window, accessible to the user via a link listed on a webpage or accessible to the user via an application (e.g., via an application for a mobile device, for a tablet, etc.), associated with the payment service provider 106, or via a webpage of another entity shown (or not shown) in FIG. 1. The user can then enter the support message in the chat window, using input device 208 of the user's computing device 200, which transmits the support message to the support engine 118. As can be appreciated, in this embodiment, the interactive interface allows for live, real-time (or near real-time, in some examples) communication and interaction between the user and the support engine 118 in connection with resolution of the issue presented by the user in the support message. In various embodiments, the interactive interface may include a option, that can be selected by the user, that directs the user to (or that enables the person to directly talk with) a real person to discuss the support message, as desired.

As part of receiving the support message from the user, the support engine 118 initiates an inquiry session, at 604. The inquiry session includes a transcript of communications and other interactions that occur between the user and the support engine 118, in connection with resolving (or attempting to resolve) the issue presented by the user in the support message. For example, the inquiry session may include responses to various questions posed to the user, such as “is the problem a recurring problem”, etc. Upon completion of the session (or earlier), the transcript of the session is then stored in memory 204 of the computing device 114 associated with the payment service provider 106, for example, for subsequent use (e.g., to ultimately resolve the problem indicated in the user's support message, to follow-up with the user on any response provided to the user's support message, to provide further assistance to the user relating to the support message, for analysis and reporting purposes, for use in resolving similar issues raised in future support messages, etc.). In some implementations, the support engine 118 also records, as part of the transcript of the session, a timestamp of events for the session as well as various details of the user, such as, for example, name, email address, phone number, priority scale for the user's support message, whether or not the problem is a recurring problem, etc.

With continued reference to FIG. 6, the support engine 118 also classifies the received support message, for privacy purposes, at 606. The classification is based on text included in the support message, and may simply include identifying whether or not the support message includes personal data. Or, such operation may include a more extensive evaluation of the support message, involving multiple classes. In some embodiments, the support message may not be classified at all. Instead, in these embodiments, any personal data identified by the support engine 118 in the support message may be purged from the text of the support message (see, e.g., method 300 in which numbers included in the text of a support message are purged in connection with operation 310, etc.).

In the method 600, in connection with classifying the support message at 606, the support engine 118 identifies (or flags) the support message as being secure, or not, at 608. A secure support message is one that includes, in the text of the support message, personal data such as a payment account number or other transaction data relating to the user, or other personal identifiers of the user (e.g., a social security number, a birth date, etc.). When the support message is identified as being secure, the support engine transmits the message to customer service personnel, at 610, associated with the payment service provider 106, for example, for resolution (e.g., so that, if needed, the customer service personnel can access the user's payment account to view transaction data, as need, to help resolve the issue presented in the support message; etc.). In some implementations, the support engine 118 also transmits a preliminary response to the user, via the interface (to a display device 206 associated with the user), indicating that the customer service personnel will contact the user directly, through the interface or otherwise, to provide a response message addressing the issue included in the user's support message.

All other requests in the method 600, not identified (or flagged) as secure, at 608, may be further processed by the support engine 118 as described hereinafter.

In particular, next, the support engine 118 normalizes the text of the support message at 612 (broadly, transforms the text to a normalized format). In the illustrated method 600, this is done in a similar manner to normalizing the support message at operation 306 in method 300. For example, the support engine 118 may merge subject text and body text of the message into a common text portion; remove numeric characters, punctuation characters, and special characters from the text of the support message; stem the text of the support message; filter the text of the support message based on words included in at least one predefined list of words; remove white spaces in the text of the support message; and/or convert the text of the support message to a common case. In addition, as described for method 300, it should be appreciated that the support engine 118, in the current method 600, may perform more or less operations than identified herein in connection with normalizing the text of the support message, or may perform different operations all together or different combinations of operations, as necessary.

After normalizing the text of the support message, the support engine 118 then assigns a value (or score) (broadly, a representation) to the support message at 614, based on the normalized text, and stores the assigned value in memory 204 of computing device 114 associated with the payment service provider 106. The assigned value may include any suitable value for, or representation of, the normalized text of the support message (e.g., any of the values described in connection with method 300, etc.). In addition, the value may be based on all words in the normalized text of the support message, or less than all words.

As an example, the support message may be represented as a vector (e.g., a score vector, etc.) (broadly, a value), where the vector comprises multiple scores, i.e., a score associated with (or assigned to) individual words in the normalized text of the support message (as previously described in connection with operation 320 of method 300). As another example, the support message may be grouped, or stacked, with a set of multiple support messages, such that all of the support messages are represented, together, as a word matrix (such as word matrix 500 in FIG. 5) (broadly, a value) where each column of the matrix represents one of multiple support messages, and each row of the matrix represents occurrence (or frequency of occurrence) of particular words in each of the indicated support messages.

As still another example, a support message may be represented as a node graphically (i.e., via a graphical representation) (broadly, a value), where the node in the graph represents a request and where edges of the graph then represent similarities (e.g., common terms shared among two requests, etc.). More particularly in such a representation, each support message represents a node. Multiple nodes, represented by multiple support messages, can then be connected based on a common number of terms shared by the support messages. The connection is called an edge, which in this example is bidirectional. When a large number of nodes and their connections are present, they can be visualized as a graph. Further, algorithms/computations, for example, as described herein, or otherwise, can be applied on these graphs. Thus, such graphical representations of support messages can provide additional insights about how the support messages are connected/related.

With further reference to FIG. 6, once the value is assigned to the normalized text of the support message, the support engine 118 identifies a response message, at 616, based on the value. In so doing, the support engine 118 operates to compute a similarity between the issue raised by the user in the support message and questions/answers already available to the support engine. As such, a goal of this operation is to determine whether or not additional information is necessary, from the user to resolve, the issue raised in the support message (and thus supporting/facilitating the interactive aspect of the method 600).

In particular in the method 600, the support engine 118 searches, at 618, in a data structure 620, which includes a plurality of reference values and associated response messages, for a value that matches (or substantially matches) the assigned value within a predefined threshold. In some embodiments, the match represents an identical match between the value assigned to the normalized text of the support message and a value in the data structure 620 (where the identical match indicates the threshold is satisfied). In other embodiments, the match represents a substantial match between the value assigned to the normalized text and a value in the data structure 620 (e.g., when the value is within the predefined threshold of a value in the data structure 620, etc.). Examples of substantial matches are provided in connection with method 300, and equally apply to method 600. In addition, it should be appreciated that any number of different matching techniques or algorithms, and any number of different inputs relating thereto, may be used to compare the value assigned to the support message to a value of one or more reference messages.

As an example, and as described in detail in connection with method 300, cosine similarity metrics may be used to determine matches between (and compare) values assigned to normalized support messages and reference values associated with response messages (e.g., stored in data structure 620, etc.). The results are then evaluated in view of one or more desired predefined thresholds, for example, determined as described in method 300 (e.g., through empirical iterations, etc.).

As another example, response messages (and specifically, their assigned values) may be clustered in the data structure 620 based on density (e.g., using a density based special clustering of applications with noise (DBSCAN) algorithm, etc.), or based on other data, such as user data (e.g., employees from the same department may be clustered together, users associated with the same issuer may be clustered together, etc.), etc. New support messages, once assigned values, are then compared and clustered in the data structure 620, in connection with the clusters of response messages, to determine matches between values assigned to the new support messages and the reference values associated with response messages. It should be appreciated that various different statistical methods (e.g., algorithms, other methods, etc.) can be used to facilitate assignment of the different messages to the clusters, such as, for example, k-means clustering, fuzzy c-means clustering, hierarchical clustering, etc., in which the different messages are clustered based on how close the corresponding values are to each other.

As still another example, graphical comparisons, using the graphical representations described above, may be used to determine matches between values assigned to support messages and reference values associated with response messages (e.g., stored in data structure 620, etc.). In this example, a graph is built with nodes as described above, where each node represents a support message and the edges amongst the nodes, i.e. connections, are built based on the number of common keywords shared between the messages. As a new message arrives, the new message will be added as a node in the graph. This is then followed by identifying the top-k closest nodes (nodes that share highest number of common words with the newly added message), which ultimately will help in providing a response to the user.

In the illustrated method 600, the data structure 620 includes a plurality of support messages (e.g., comprises a knowledge base of reference messages, etc.), to which (or with which) labels and/or response messages have previously been assigned (or associated) (see, e.g., method 300). Each of the reference messages is associated with a reference value, which is determined in a similar manner to the value of the support message, or not.

In particular, the reference messages in the data structure 620 may include predefined solutions to common issues routinely addressed by the support engine (e.g., historical issues and solutions, etc.), solutions provided by customer service personnel (e.g., domain experts, etc.) to different encountered issues, and crowdsourced solutions (e.g., from customer service personnel, etc.) to various issues. The crowdsourced solutions can be voted on by both users and domain experts, and can also be verified by the domain experts. If a solution is verified, it will be flagged and can then be included in the reference solution database, i.e., data structure 620, as a standard response. Further, in some cases, the crowdsourced solutions can even initially be proposed by the users and/or domain experts.

As such, the plurality of reference messages available in the data structure 620 can be continuously expanded, based on current messages as well as input from customer service personnel, crowdsourced or otherwise. Thus, the data structure 620 can be expanded by routinely updating the responses, in real time, based on each new support message, and the resulting response message, by taking into account frequency of common issues, etc. In some aspects, the response messages provided by the customer service personnel may also be rated or ranked to improve accuracy of response messages. Further, in some aspects, when multiple different response messages are provided for a given support message, the support engine may facilitate a crowdsourced vote to select the most accurate response message (e.g., users and domain experts can participate and vote or they can provide their own response messages, etc.).

As an example, the reference messages in the data structure 620 may include predefined historical messages, and their associated responses, compiled as described in method 300 (e.g., based on common issues raised in multiple prior support messages, collected from prior support messages and confirmed responses thereto, etc.). The reference messages may also include recent messages, for example, confirmed by customer service personnel (e.g., for secure support messages processed directly by customer service personnel, etc.). In addition, the reference messages may further include crowdsourced response messages provided by customer service personnel (e.g., via a particular interface available to the customer service personnel, etc.), and based on personal experience, for various support messages also submitted by customer service personnel or other users (e.g., for support messages not normally encountered, for example, addressing how to install some software which is not used by everyone, etc.).

As described, the response messages in the data structure 620 may include predictive labels (see, e.g., method 300 and Table 1), although this is not required. The labels describe, briefly, issues and/or questions raised in the original support messages. The labels may then be used in one or more ways, by customer service personnel, to verify and/or check response messages, regularly or at certain regular or irregular intervals, to confirm performance of the support engine 118. The response messages also generally include predefined solutions for the issues and/or questions (e.g., videos, links to videos/documents, webpages, self-help instructions, blogs, etc.) based on, at least in part, prior manual analysis of the reference messages and/or continued review of support messages processed according to the automated methods herein, for example, by the support engine 118.

With reference again to FIG. 6, when the value assigned to the support message matches (or substantially matches) one of the plurality of reference values in the data structure 620, at 622, the support engine 118 retrieves the response message associated with the matching reference value at 624. The support engine 118 then automatically transmits the response to the user, via the interface, at 626 (to the display device 206 associated with the user). In this manner, the support engine provides a real-time response to the user's issue (and support message). The response message generally includes at least one instruction related to the issue included in the support message. The at least one instruction will be specific to the issue, and will provide one or more solutions for the issue. Any suitable format may be used to convey this information to the customer, either directly in the response message, or through content linked to the response message. For example, the response message may include, without limitation, a written description of the solution, a video tutorial relating to the issue indicated in the support message, a user manual relating to the issue indicated in the support message, a link (e.g., a URL, etc.) to a written description relating to the issue indicated in the support message, and/or a link to a video description relating to the issue indicated in the support message.

Conversely, when the value assigned to the request does not match (or does not substantially match) one of the plurality of reference values in the data structure 620, at 622, the support engine 118 determines how many attempts have been made to respond to the user's support message at 628, and whether or not to continue evaluating the support message. If only one attempt has been made, the support engine 118 requests additional information from the user at 630, via the interface, relating to the issue described by the user in the support message. At the same time, in some implementations, the support engine 118 may also transmit one or more of the closest response messages, addressing the user's support message, as suggestions for self-solving the user's issue or to potentially help the user in updating his/her support message. The support engine 118 then repeats the above operations 606-622 in connection with the additional information (and the updated support message). If more than one attempt has already been made to respond to the user's request and the support engine 118 still cannot identify a matching (or substantially matching) response message, the support engine 118 transmits the support message to customer service personnel at 610, for example, associated with the payment service provider 106 for resolution. In some implementations, the support engine 118 also transmits a notification to the user, via the interface, indicating that the customer service personnel will contact the user directly, through the interface or otherwise, to provide a response message addressing the issue raised in the user's support message (e.g., upon review the transcript associated with the user's inquiry session, etc.).

When the user's inquiry session is completed, for example, when a response message addressing the issue raised in the user's support message is transmitted to the user, the support engine 118 appends the support message and corresponding response message to the data structure 620 at 632. In some embodiments, in so doing, the support engine 118 may cluster the support message with other messages in the data structure 620 for subsequent use in matching reference messages with new support messages. If no close matches are found, the support message may then be labeled for future use/reference. After collecting multiple un-clustered messages, the support engine 118 can then again attempt to cluster the un-clustered support messages in part (or based on the whole set).

Further, the support engine 118 may then generate various reports (e.g., functioning as a reporting engine, etc.) relating to the issue raised in the resolved support message, for review and/or analysis, including cluster size and trending keywords. The trending keywords from each cluster in the data structure 620 can then be computed and compared. Further, a time series analysis on support message count can be conducted. In general, clustering is performed on the support messages, i.e., the support messages are grouped based on their similarity. The clustering algorithm used takes the matrix (messages) as input for grouping the messages. The features of the clustering algorithm would be the words and the input would be the word-document matrix. This is then generally followed by finding the most-occurring/repeated words in each cluster, called trending. In various cases, a domain expert may then look at the final clusters and provide an evaluation.

At this point, while the support engine 118 is described herein (e.g., in connection with payment network 100, method 300, method 600, etc.) as accommodating a single user, it should be appreciated that the support engine 118 can accommodate multiple users, and multiple sessions, simultaneously (or substantially simultaneously) within the scope of the present disclosure.

In some embodiments, prior to (or after) normalizing the text of the support message, or at a different time, the support engine 118 may perform a keyword search for particular terms in the message, for example, application names, product names, specific problem types, etc. The support engine 118 may then search in the data structure 620 for similar terms, to determine an appropriate response message, for example, in lieu of assigning a value to the support message. Or, the support engine 118 may use this search to preliminarily narrow possible response messages, prior to assigning a value to the support message.

FIG. 7 illustrates an interactive collective intelligence-based ticket resolution system 700, in which one or more aspects of the present disclosure is implemented. The system 700 is operable to perform one or more functions described herein, for example, in method 300, method 600, etc. in a similar manner to the support engine 118 of the payment network 100, etc. As such the system 700 is described with reference to the support engine 118, the method 300, and the method 600. However, other implementations are possible such that the system 700 should not be considered limited to the support engine 118, the method 300, or the method 600, and vice versa. More particularly, the system 700 is operable to process support messages (broadly, requests) from users identifying issues, encountered by the users, relating to one or more features of applications available to the users, for example, through various organizations or entities (e.g., through various merchants, networks, etc.).

As shown in FIG. 7, the system 700 generally includes a natural language interpreter 702 (or processing engine), a solution engine 704, and a reporting engine 706. The interpreter 702, the solution engine 704, and the reporting engine 706, together, generally operate in a similar manner to the support engine 118 (such that they can generally be considered components of the support engine 118 in some embodiments). In particular, the interpreter 702 is configured to convert natural language text to machine understandable enquiry. While the solution engine 704 is configured to match requests with the appropriate requests, and responses, already existing in the system 700, and replies with the existing solution and requests additional information, when needed. The reporting engine 706 is then configured to transmit the appropriate response to the user.

Generally, in operation of the system 700, a user provides a request 708 (e.g., a support message or enquiry, etc.) to the system 700 via a chat window 710 (displayed to the user via a display device 206 of a computing device 200 associated with the user).

Upon receipt of the request 708, the system 700 initially identifies a type for the request 708 (e.g., classifies the request 708, etc.) by reading through text in the request 708. Some types of requests received by the system 700 require customer service personnel to assist, since they involve details about transactions, etc. (see, e.g., operation 606 in method 600, etc.). For example, these types of requests may require customer service personnel to look up transaction data, and related transactions, using payment account numbers for the users, etc. As such, these types of requests need to be marked up (e.g., flagged, classified as secure, etc.) as ones which require mandatory follow-ups by customer assistance personnel. Other requests can be processed, and automatically resolved, by the system 700, and may or may not also require (or activate) follow-ups by customer service personnel. Any of the requests that require human attention are transmitted, by the system 700, to an appropriate customer service personnel for assistance, for example, based on their labels (see, e.g., method 300, and Table 1, and method 600 describing operations of labeling support messages, etc.).

Next, the interpreter 702 converts the request 708 (i.e., text of the request 708) to a machine understandable enquiry 712. For example, the interpreter 702 may convert natural language text of the request 708 to a numerical vector by building the text into a term-frequency vector. Meanwhile, reference responses (associated reference values), stored in a knowledge base 714 (e.g., data structure 324, data structure 620, etc.) (broadly, a memory) are already represented in a document-term matrix form. As such, the converted text of the request 708 (i.e., the machine understandable enquiry 712) can be compared, for similarity, to the collection (or library) of reference responses, in the knowledge base 714, available to the system 700. As previously described, the knowledge base 714 may include reference responses from various sources, including from an initial solution base, at 716, such as historical requests and responses, domain expert provided responses to particular requests, and crowdsourced responses to particular request, and newly added reference responses from users, at 718.

In various embodiments, the interpreter 702 may also perform keyword searches of the support message, for example, to identify particular application names, product names, specific problem types, etc. The interpreter 702 may then search in a data structure (e.g., the data structure 620, etc.) for similar terms, to determine an appropriate response message. Or, the interpreter 702 may use this search to preliminarily narrow possible response messages (or to help cluster the support message), prior to assigning a value to the support message. Further, the interpreter 702 may perform a word count of the support message to provide insight into the appropriate response message.

The reference responses included in the knowledge base 714 of the system 700 can be derived from various sources. For example, the reference responses may come from the initial solution base, at 716, or from the crowdsourced responses, at 718. The crowdsourced responses may come from internal messages from customer service personnel or other domain experts, for example, posted in response to particular requests for solutions, posted as responses to prior encountered support messages, or even posted in combination with a particular problem also encountered or contemplated by the customer service personnel or other domain experts. In addition, the customer service personnel or other domain experts may post the crowdsourced support messages, for example, based on their personal experiences, for various support messages submitted by other customer service personnel or other users, or based on other reasons. Further, the support messages posted in connection with the crowdsourcing may be unique in nature, for example, and not normally encountered by users. Moreover, in various embodiments, the crowdsourced responses are reviewed, or verified, prior to being provided to users. If, or when, a solution is verified, it is also flagged and identified (and included, as needed) in the knowledge base 714 as a standard response for subsequent use. Such review can be internal, external, or by certain user groups (e.g., product specific groups, technical knowledge-specific groups, etc.). In addition, in some aspects, the crowdsourced solutions can be proposed and/or voted on by the customer service personnel or other domain experts, and then also verified as needed by the same or different customer service personnel or other domain experts. Moreover, when solutions are provided that replace prior solutions, the prior solutions may be purged from the knowledge base 714 as appropriate.

At this point, the request 708 is generally represented in a structured format, for example, the numerical vector. As a note, clustering is generally done ahead of time, and when a new support message comes in, the support engine 118 scores it based on the clustering results to see which cluster it belongs to. Once the new request 708 is identified to the closest cluster, the solution engine 704 identifies a top-k closest reference request from the cluster to the new request, and retrieves the response 720 associated therewith. The solution engine 704 will then decide whether or not to collect more information about the request 708, from the user, based on the results of the identification (and how close the identified response 720 is to the issue raised in the request 708). For example, if the results are within a predefined threshold, the reporting engine 706 transmits the response 720 to the user. Otherwise, the solution engine 704 collects more information to further process the request 708.

Once a response is identified, and transmitted to the user, the system 700 stores a transcript of the chat-session/history. The stored transcript can then be reviewed by customer service personnel and, as necessary or required, the customer service personnel can follow-up with the user, at 722, based on contact data collected during the session.

In some embodiments, the solution engine 704 of the system 700 may utilize a fuzzy-based unsupervised learning mechanism that is operable to provide multiple responses to a request based on relevance. In these embodiments, the responses can then be ordered or ranked for relevance.

As can be seen, the payment networks, systems and methods of the present disclosure provide various advantages in connection with processing support messages to payment networks. Historical support messages, and the customer service personnel intervention with those support messages, are utilized, based on similarities with current issues in the payment network, to recommend solutions, instructions, or courses of action for particular issues in the payment network, thereby providing for more efficient use of the support personnel.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations described in the claims, or otherwise herein.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” or “coupled to” another element, it may be directly on, connected or coupled to the other element, or intervening elements may be present. In contrast, when an element is referred to as being “directly on,” “directly connected to,” or “directly coupled to” another element, there may be no intervening elements present. As used herein, the term “and/or” includes any and all combinations of one or more of the associated listed items.

What is claimed is:

1. A computer-implemented method of processing a request, from a user, for support relating to one or more features of an application available to the user, the method comprising:
receiving, via an interface, a request for support from a user relating to an application available to the user, the request including text describing an issue relating to one or more features of the application;
assigning, by the computing device, a value to the request based on the text included in the request;
searching in a data structure, by the computing device, for the value assigned to the request, the data structure including a plurality of reference values each associated with a response;
when the value assigned to the request substantially matches one of the plurality of reference values in the data structure:
identifying, by the computing device, the response associated with said matching reference value; and
transmitting the response to the user, via the interface; and
when the value assigned to the request does not substantially match one of the plurality of reference values in the data structure, requesting additional information from the user, via the interface, relating to the issue described by the user.

2. The computer-implemented method of claim 1, wherein the interface includes an interactive interface.

3. The computer-implemented method of claim 2, wherein the interactive interface includes a chat window.

4. The computer-implemented method of claim 1, wherein the value assigned to the request is selected from the group consisting of a vector, a matrix, and a graph.

5. The computer-implemented method of claim 1, wherein the value assigned to the request substantially matches one the plurality of reference values when said value, when compared to the one of the plurality of reference values, exceeds a predefined threshold.

6. The computer-implemented method of claim 1, further comprising:
initiating an inquiry session, by the computing device, when the request is received from the user; and
storing, by the computing device, a transcript of the inquiry session.

7. The computer-implemented method of claim 6, further comprising transmitting, by the computing device, the transcript to an inquiry representative when the value assigned to the request does not substantially match one of the plurality of reference values in the data structure, the transcript including the additional information from the user relating to the issue described by the user.

8. The computer-implemented method of claim 1, wherein the application is associated with a payment network; and
further comprising:
classifying, by the computing device, the request, based on the text included in the request; and
transmitting the request, by the computing device, to an inquiry representative associated with the payment network when the text included in the request includes a payment account number.

9. The computer-implemented method of claim 1, further comprising transforming, by the computing device, the text included in the request to a normalized format.

10. The computer-implemented method of claim 1, wherein the response is selected from one of a historical response and a crowdsourced response.

11. The computer-implemented method of claim 10, wherein the response is a crowdsourced response; and
wherein identifying the response further includes receiving, by the computing device, votes relating to the response.

12. A system for use in processing a request, from a user, for support relating to one or more features of an application available to the user, the system comprising:
a memory including a data structure comprising multiple reference values, each of the multiple reference values associated with a response addressing an issue related to one or more features of an application; and
an engine coupled to the memory, the engine configured to:
normalize text included in a request received from a user via an interactive interface, the text included in the request describing an issue related to one or more features of an application available to the user;
assign a value to the request based on the normalized text;
when the value assigned to the request substantially matches one of the reference values in the data structure, transmit the response associated with the matched one of the reference values to the user via the interactive interface; and
when the value assigned to the request does not substantially match one of the reference values in the data structure, request additional information from the user, via the interactive interface, relating to the issue described by the user in the request.

13. The system of claim 12, wherein the value assigned to the request substantially matches one of the reference values in the data structure when said value, when compared to the one of the reference values in the data structure, exceeds a predefined threshold.

14. The system of claim 13, wherein the value assigned to the response is selected from the group consisting of a vector, a matrix, and a graph.

15. The system of claim 12, further comprising a payment service provider, the application associated with the payment service provider;
wherein the engine is further configured to:
classify the request based on the text included in the request; and
flag the request when the text included in the request identifies a payment account.

16. The system of claim 12, wherein the data structure, included in the memory, comprises multiple responses each associated with a reference value, each of the multiple responses associated with either a predefined answer or a crowdsourced answer.

17. The system of claim 12, wherein the interactive interface includes a chat window; and
wherein at least one of the multiple responses is a crowdsourced response previously associated with a request from a user for support relating to one or more features of an application available to said user.

18. A non-transitory computer readable storage media comprising computer-executable instructions that, when executed by at least one processor, cause the at least one processor to:
display an interactive interface to a user;
normalize text included in a request received from a user via the interactive interface, the text included in the request describing an issue related to one or more features of a payment application available to the user through a payment service provider;
assign and store a value to the request based on the normalized text;
search, in a data structure, for the value assigned to the request, the data structure including a plurality of reference values each associated with a response; and
when the value assigned to the request substantially matches one of the reference values in the data structure, transmit the response associated with the matched one of the reference values to the user via the interactive interface.

19. The non-transitory computer readable storage media of claim 18, wherein the value assigned to the request substantially matches one of the reference values in the data structure when said value, when compared to the one of the reference values in the data structure, exceeds a predefined threshold.

20. The non-transitory computer readable storage media of claim 18, wherein the value assigned to the response is selected from the group consisting of a vector, a matrix, and a graph.
